(19) United States
(12) Patent Application Publication
(10) Pub. No.: US 2008/0055274 A1
(43) Pub. Date: Mar. 6, 2008

(54) Display And Input Device

(75) Inventors: Cornelis Van Berkel, Hove (GB); Steven C. Deane, Redhill (GB)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: Koninklijke Philips Electronics N.V., Eindhoven (NL)

(21) Appl. No.: 10/566,076

(22) PCT Filed: Jul. 22, 2004
(86) PCT No.: PCT/IB04/02388

§ 371 Date: Jan. 25, 2006

(30) Foreign Application Priority Data
Jul. 29, 2003 (GB) 0317715.1

(51) Int. Cl. G06F 3/041

(52) U.S. Cl. 345/174

(57) ABSTRACT

A display and input device, comprising a substrate (30), for example a flexible conducting foil, comprising a front surface (8) and a rear surface (10); a plurality of layers (32, 34, 35, 36, 37, 39) provided on the front surface (8) of the substrate (30), the plurality of layers (32, 34, 35, 36, 37, 39) being operable as a display, for example an electrophoretic display, viewable from the front surface side of the device; and circuitry (52, 54) connected to the substrate (30) for detecting capacitive coupling between a user's finger (12) and the substrate (30) such that the substrate (30) is operable as a touchpad for sensing a user's finger (12) touching, or being located in close proximity to, the rear surface (10) of the substrate (30).

The present invention relates to displays and input devices, particularly touchscreen or touchpad devices. The present invention also relates to electronic equipment incorporating displays and input devices, in particular hand held electronic equipment.

A wide variety of electronic equipment comprises a flat screen display and one or more user input means. Such equipment includes, by way of example, so called laptop computers, telephones including mobile telephones, and personal digital assistants (PDA's), the latter also being known as personal organisers.

Various different flat screen display technologies are known. Well known technologies that have been extensively commercialised and mass produced include, for example, liquid crystal displays (LCD's) and electroluminescent displays. A less well known display technology that has recently shown potential is that of electrophoretic displays, as disclosed for example in “A Conformable Electronic Ink Display using a Foil-Based a-Si TFT Array”, Y. Chen et al., SID 01 DIGEST, 2001, pages 157-159; Flexible, Active-matrix Display Constructed Using a Microencapsulated Electrophoretic material and an Organic-Semiconductor-based backplane”, K. Amundson et al., SID 01 DIGEST, 2001, pages 160-163; and “Card-size Active-matrix Electronic Ink Display”, P. Kazlas et al., EURODISPLAY 2002, pages 259-262. Such displays are formed on a flexible foil substrate, hence providing a flexible display whose display screen may be flexed to non-flat profiles whilst retaining a good display image.

Various different user input means are known, including switches, mechanically operated keyboards, and a computer mouse. When a user operates the input means, a processor in the equipment processes the input and usually changes the display image accordingly. In most equipment such input means are positioned so as to be in view of a user when the user is viewing the display.

Another form of input means is a touchpad. One known technology for providing a touchpad is resistive technology, another is capacitive technology.

In some equipment a display device and a touchpad-type input means are implemented in the form of an integrated display and user input device. Such devices are often referred to as “touchscreen” devices. In these cases, a user presses the front of the display, or touches the front of the display, directly or with an object, or places an object or e.g. a finger close to the front of the display, at a desired location on the display area. The location on the display area often represents a choice of inputs displayed on the screen.

For example, in the case of “capacitive touchscreen” technology, a user's finger, for example, makes capacitive contact to an added transparent conducting layer on the front of the display screen through which the user views the screen. The added transparent conducting layer is held at a low voltage and a small current flows through the user's finger and body to earth. This current is supplied by voltage sources at edges of the touchscreen and, by comparing the magnitude of the respective currents from the respective voltage sources, the location of the touch point may be determined.

In any equipment incorporating a touchscreen, but particularly in small hand held equipment, the requirement for the finger to be placed on or very near the front of the display screen causes disadvantages. One disadvantage is that the finger obscures the most significant part of the image displayed. Another disadvantage is that grease and dirt may be accumulated on the display screen, or it may be physically damaged or scratched, impairing image quality. Yet another disadvantage is that accurate positional calibration is required between a co-ordinate location on the display device and the corresponding co-ordinate location as far as the input means is concerned (i.e. there is a harsher requirement for the finger position to be in accordance with the display co-ordinates than there would be with an indirect input arrangement comprising e.g. mouse plus a cursor on the screen, as the cursor leads the user to the accurate display point by means of relative adjustment, which process is not possible with just the real finger and no cursor).

In order to alleviate the disadvantages referred to in the preceding paragraph, hand held electronic equipment have been disclosed in which a display module is provided on a front face of the housing of the equipment, and a separate touchpad is provided on the rear surface of the housing of the equipment. For example, GB-A-2 344 905 discloses a personal digital assistant with an LCD on the front side and a touchpad on the rear side, U.S. Pat. No. 5,543,588 discloses a handheld computing device with a display screen a front face and a touch-sensitive object position detector input device on the rear side, and EP-A-0 913 977 discloses a radiotelephone handset with a display on a front face and input means on the rear face.

The present inventors have realised that further disadvantages arise in the case of electronic equipment as described in the preceding paragraph, especially hand held electronic equipment, in which a display module is provided on a front face of the housing of the equipment, and a separate touchpad is provided on the rear surface of the housing of the equipment. For example, by requiring a separate display device and touchpad device, component count and assembly requirements are increased, and the overall thickness required for a separate display device and touchpad to be located over each other may be undesirable. The present inventors have realised that it would be desirable to provide a way of achieving the integration advantages of touchscreen devices with the rear-handling advantages of devices such as those described in the preceding paragraph, which advantages have conventionally been understood to be mutually exclusive.

Moreover, the present inventors are not aware of any disclosure of flexible displays, such as the thin foil based electrophoretic displays described above, provided with a separate rear touchscreen. However, the present inventors have realised that were these to be implemented using the conventional approach, then a new problem, not applicable with rigid display devices, might arise, namely that when the display surface is flexed, the positional correspondence, calibration or mapping between the display device and the touchpad will be compromised. Hence the present inventors have realised that it would be desirable to provide a form of display device and touchpad capability that would inherently avoid, reduce or eliminate any such effect when a flexible display is flexed.

In a first aspect, the present invention provides a display and input device, comprising: a substrate comprising a front surface and a rear surface; a plurality of layers provided on the front surface of the substrate, the plurality of layers being operable as a display viewable from the front surface side of the device; and circuitry connected to the substrate for detecting capacitive coupling between a user's finger and the substrate such that the substrate is operable as a touchpad for sensing a user's finger touching, or being located in close proximity to, the rear surface of the substrate.

This tends to provide a combined display and input device that may reduce the number of separate modules required in electronic equipment, and/or may reduce overall size requirements, whilst surprisingly often not requiring any more components or layers than would be present in a device performing just the display function alone.

The substrate may be flexible. In this case the device may advantageously provide at least some extent of inherent positional correspondence, calibration or mapping between the display and the touchpad functions of the combined device when flexed.

The substrate may be made of a conducting material, and may for example comprise a flexible foil. In these cases the above described advantages tend to be amplified.

Another possibility is that the substrate may be made of an insulating material with a conductive coating on the rear surface. This allows a wider choice of substrate material.

The substrate may comprise a protective coating on the rear surface, the protective coating being sufficiently thin to allow the capacitive coupling between a user's finger and the substrate to be detected. This allows physical protection of the substrate, which is particularly advantageous with thin substrates, whilst still retaining useful touchpad operation.

The display type may be an electrophoretic display. In this case the substrate characteristics of known electrophoretic displays, especially encapsulated electrophoretic displays, are particularly suited to use as a rear surface touch screen pad.

The circuitry comprises a plurality of ammeters, each connected to a different point on the edge of the substrate.

The substrate may be substantially rectangular and the plurality of ammeters may comprise a respective ammeter placed at each corner of the substrate.

In a further aspect, the present invention provides the use of a display device as a combined display and input device, the display device comprising a substrate comprising a front surface and a rear surface, and a plurality of layers provided on the front surface of the substrate, the plurality of layers being operable as a display, wherein the use as a combined display and input device is implemented by using the rear surface of the substrate as a capacitive coupling sheet.

Embodiments of the present invention will now be described, by way of example, with reference to the accompanying drawings, in which:

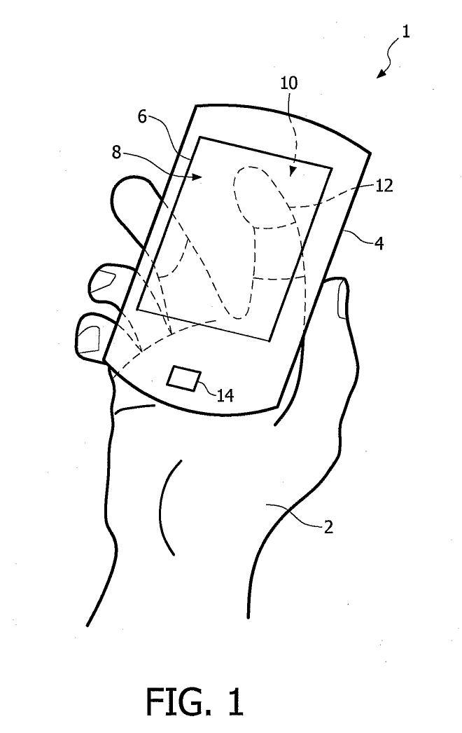

FIG. 1 is a schematic illustration (not to scale) of a personal digital assistant (PDA), being held in a user's hand;

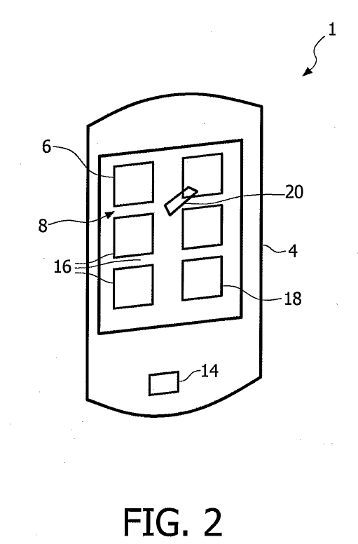

FIG. 2 is a further schematic illustration (not to scale) of the personal digital assistant (PDA) of FIG. 1, showing an example of a displayed image which can be viewed at the front surface of a display and input device comprised by the PDA;

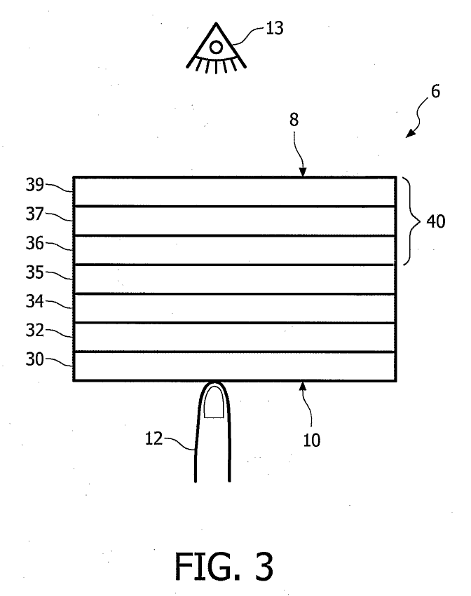

FIG. 3 is a schematic illustration of a cross-sectional view of various layers comprised by the display and input device mentioned above with respect to FIG. 2;

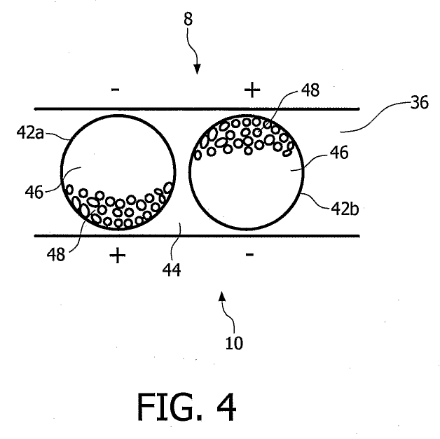

FIG. 4 is a schematic illustration (not to scale) showing details of an electrophoretic layer comprised by the display and input device mentioned above with respect to FIGS. 2 and 3;

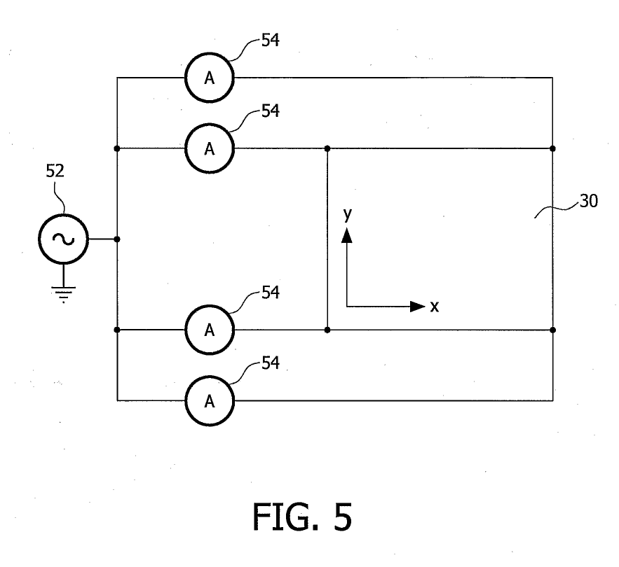

FIG. 5 is a schematic illustration of certain components providing the input functionality of the display and input device mentioned above with respect to FIGS. 2 to 4;

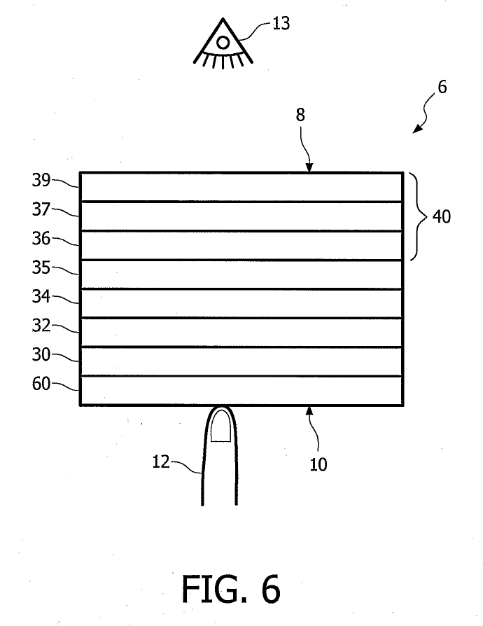

FIG. 6 is a schematic illustration of a cross-sectional view of another display and input device in which a protective layer is provided over the outer surface of a foil substrate.

FIG. 1 is a schematic illustration (not to scale) of a personal digital assistant (PDA) 1, according to the first embodiment of the invention, being held in a user's hand.

The PDA 1 comprises a plastic housing 4, in which is mounted a display and input device 6. The display and input device 6 has a front surface 8 and a rear surface 10. The front surface 8 functions as the display output of the display and input device 6, and in use the displayed image can be viewed at the front surface 8. For clarity no image content is shown in FIG. 1, this will instead be shown in FIG. 2 to be described later below.

In use, the user's hand 2 grips the housing 4, such that the front surface 8 of the display and input device 6 faces the user and can be viewed by him or her.

Furthermore, this grip allows the user to use a finger 12 to touch or press different locations on the rear surface 10 of the display and input device 6, by way of providing an input, comprising for example data, instructions or choices to the PDA 1, without obscuring the view of the front surface 8 and without needing to touch the front surface 8, as will be explained in more detail below.

Preferably, the finger 12 used to touch the rear surface 10 is the index finger or middle finger of the same hand 2 as is gripping the housing 4 (or simultaneous or mixed use of these fingers is also possible).

Other inputs may be provided in addition to the display and input device 6, as required. For example, in this embodiment the PDA 1 comprises an on/off switch 14. In this embodiment, all other inputs are provided via the display and input device 6.

The PDA 1 further comprises a power supply, in the form of a rechargeable battery (not shown). The PDA 1 further comprises control circuitry (not shown), including a processor, for controlling the operation of the PDA 1. The control circuitry controls the operation of the PDA 1 in conventional fashion, including conventional control and driving of display operations of the display and input device 6. In addition, the control circuitry controls sensing and processing of the user's inputs provided by touching the rear surface 10 of the display and input device 6, as will be explained in more detail below. The control circuitry is mounted inside the housing 4 in an area not covered by the display and input device 6.

FIG. 2 is a further schematic illustration (not to scale) of the personal digital assistant (PDA) 1, according to the first embodiment of the invention, showing an example of a displayed image 16 which can be viewed at the front surface 8 of the of the display and input device 20.

The image 16 comprises a plurality of icons 18 representing user choices or inputs. For example, if the image 16 is the image displayed each time the PDA 1 is turned on, then each icon 18 may represent a PDA function that the user may select, for example calendar, calculator, address book and so on.

The image further comprises a cursor 20. The control circuitry moves the cursor 20 on the image 16 in correspondence to the movement of the user's finger 12 on the rear surface 10 of the display and input device 6, as will be explained below. A particular icon 18 is selected when the cursor is left positioned over that icon 18 for a given amount of time, e.g. half a second. In other embodiments, a separate switch or touch pad area may be provided to allow the user to select a given icon 18 over which the cursor 16 is positioned at a given moment.

The display and input device 6 is fabricated as a multi-layer device, which will now be described in more detail with reference to FIG. 3. FIG. 3 is a schematic illustration of a cross-sectional view of various layers comprised by the display and input device 6.

The display and input device 6 comprises, at the rear surface 10 side, a 250 μm thick, grade 304 conductive stainless steel foil substrate 30 polished on one side (i.e. this is an example of a flexible conducting substrate). An insulating passivation layer 32 is deposited over the polished side of the foil substrate 30. An active matrix layer 34 is formed on the passivation layer 32. The active matrix layer 34 is itself formed of a number of semiconducting and insulating layers so as to provide, in conventional fashion, an array of thin film transistors (TFT's).

A structure referred to as “electronic ink” 40 is laminated on the active matrix layer 34 by means of a glue layer 35. The electronic ink 40 comprises a microencapsulated electrophoretic material 36 (and a polymer binder) coated onto a 125 μm thick indium tin oxide (ITO) 37 coated polyester sheet 39. Thus, in terms of the layer structure of FIG. 3, the glue layer 35 is over the active matrix layer 34, the electrophoretic layer 36 is positioned over the glue layer 35, the ITO layer 37 is over the electrophoretic layer 36, and the polyester sheet 39 is over the ITO layer 37, and moreover provides the front surface 8 of the display and input device 6.

For display operation of the display and input device 6, the TFT's of the active matrix layer 34 are addressed and driven in conventional active matrix display device fashion, and the ITO layer 37 is used as the common electrode plane in conventional active matrix display device fashion. The electro-optic effect provided by the electrophoretic layer in response to the resulting fields across the electrophoretic layer 36 will be described below with reference to FIG. 4.

Also shown schematically in FIG. 3 is that the display and input device 6 is viewed from the front surface 8 side of the display and input device 6, as represented by the user's eye 13 being on that side of the display and input device 6, whereas the touch input from the user's finger 12 is provided at the rear surface 10 of the substrate 30, i.e. at the rear surface 10 side of the display and input device 6.

FIG. 4 is a schematic illustration (not to scale) showing further details of the electrophoretic layer 36. The electrophoretic layer 36 comprises microcapsules 42a and 42b in a polymer binder 44. The microcapsules 42a, 42b each comprise a dyed fluid 46 and electrophoretic pigment particles 48. Such a material (for example in the form of the above described electronic ink 40 comprising the polyester sheet 39 with ITO layer 37 and electrophoretic layer 36) may be obtained from E Ink Corporation, 733 Concord Avenue, Cambridge, Mass. 02138, USA.

The electrophoretic pigment particles 48 move to one side or other of the respective microcapsules 42a, 42b according to the positive or negative sense of a voltage applied across them (the voltage is applied between respective TFT's of the active matrix layer 34 and the ITO layer 37). In the schematic illustration of FIG. 4, the sense of the applied voltage across microcapsule 42a means the electrophoretic pigment particles 48 are attracted to the side of the microcapsule 42a closest to the rear surface 10 of the display and input device 6, whereas the opposite sense of the applied voltage across microcapsule 42b means the electrophoretic pigment particles 48 are attracted to the side of the microcapsule 42b closest to the front surface 8 of the display and input device 6. The dyed fluid 46 is dark, e.g. black. The electrophoretic pigment particles 48 are light, e.g. white. Thus, when viewed from the side of the front surface 8, the microcapsule 42a appears black as the light is absorbed by the black dyed fluid 46, whereas the microcapsule 42b appears white as the light is backscattered by the white electrophoretic pigment particles 48.

In other embodiments the microcapsules contain a clear fluid, and two sets of electrophoretic pigment particles are provided in each microcapsule. One set are dark e.g. black, and attracted in one voltage polarity direction. The other set are light e.g. white, and attracted in the opposite voltage polarity direction.

The above multi-layer structure, as described with reference to FIG. 3, and the operation of the electrophoretic layer 36, as described with reference to FIG. 4, correspond to a known electrophoretic display device (but without additional input means), as described for example in the above mentioned Chen et al. reference, and further details are as described in that reference, which reference is incorporated herein by reference.

FIG. 5 is a schematic illustration of certain components providing the input functionality of the display and input device 6. The foil substrate 30 is used as a resistive sheet sensing surface. An alternating voltage source 52 is coupled to each corner of the foil substrate 30 via respective ammeters 54. Outputs from the ammeters 54 are coupled to processing circuitry (not shown).

In operation, the user's finger 12 touches (or is placed very near) the surface of the foil substrate 30 (i.e. the rear surface 10 of the display and input device 6). A circuit to earth is then completed through the user's body due to capacitive coupling between the user's finger 12 and the foil substrate 30. In conventional fashion, the relative magnitudes of the respective currents measured by each of the four ammeters 54 are processed to determine the position of the user's finger 12 relative to the corners of the foil substrate, e.g. the position in terms of x and y co-ordinates. The alternating voltage source, the ammeters, and position processing means are implemented as part of the previously mentioned control circuitry of the PDA 1. These aspects may however conveniently be implemented in a separate module attached to the display and input device 6, possibly with display driver circuitry, thereby providing a self-contained display and input device for use as a modular component source for manufacturers of electronic equipment.

FIG. 6 shows another embodiment in which a protective layer 60, here an insulator layer of a few μm thickness is provided over the outer surface of the foil substrate 30 (the same reference numerals are used to indicate the same layers described above with reference to FIG. 3). The protective layer 60 provides physical protection for the metal foil 30. The protective layer 60 is made sufficiently thin to allow the above described capacitive coupling with the user's finger 12 to be substantially undiminished compared to if the protective layer was not present, or at least sufficiently undiminished such that the capacitive coupling may still be detected.

In the above embodiments the PDA housing is shaped such as to encourage the user to hold the PDA in the palm of his or her hand, and to touch the rear surface of the display and input device using the index finger and/or middle finger of the same hand as is holding the PDA. Nevertheless, the user may of course use whichever fingers of the holding hand and/or his or her other hand as he or she wishes. In other embodiments, the PDA or other electronic equipment may be shaped so as to encourage the user to use other fingers, e.g. one or more fingers of the hand that is not holding the equipment.

In the above embodiments the display and input device provides the whole thickness of the PDA at that part of the PDA. As there is no need to provide a display device and an input touch pad separately, the thickness of this part of the PDA, and indeed the thickness of the whole PDA, may be significantly reduced compared to conventional arrangements.

However, in other embodiments, where desired, the display and input device may be provided in a recess of a relatively thicker overall PDA housing, and the recess may be filled or covered over with a transparent material, e.g. transparent plastic or glass.

In the above embodiments, the display and input device is used in a PDA. However, the display and input device may be used in any other suitable electronic equipment, especially hand held equipment, for example telephones, including mobile telephones, palm computers, and so on.

Furthermore, the display and input device of any of the above embodiments may be packaged and provided as a self-contained display and input device for use as a modular component source for manufacturers of electronic equipment. Such a device may include as large a proportion of display driver and/or position sensing circuitry as is desired.

In the above embodiments the display and input device is based upon a flexible substrate. In other embodiments, rigid substrates may be used.

However, when the substrate is indeed flexible, the present invention provides the advantage that the input sensing position automatically tracks the display position when the device is flexed into a non-flat surface profile. The housing of the electronic equipment may be designed to allow such flexing. Another aspect is that when a flexible display and input device is provided as a modular component source for manufacturers of electronic equipment, this will allow designers of such equipment a degree of design freedom (for flexing) not conventionally allowed, or at least with the knowledge that positional correspondence between the display and the input aspects when flexed will, at least to some extent, be inherently maintained.

In the above embodiments, the display and input device is based upon a conducting (e.g. stainless steel) substrate. In other embodiments, an insulating substrate (for example mylar) with a conducting coating may be used.

In the above embodiments, the light modulation part of the display functionality of the display and input device is provided by an encapsulated electrophoretic layer. In other embodiments, unencapsulated electrophoretic material may be used. Furthermore, in other embodiments, other electro-optic effects or materials may be used, for example a display function provided by Active Matrix Polymer Light Emitting Diode (AMPLED) on steel foil.

1. A display and input device, comprising:
a substrate comprising a front surface and a rear surface;
a plurality of layers provided on the front surface of the substrate, the plurality of layers being operable as a display viewable from the front surface side of the device; and
circuitry connected to the substrate for detecting capacitive coupling between a user's finger and the substrate such that the substrate is operable as a touchpad for sensing a user's finger touching, or being located in close proximity to, the rear surface of the substrate.

2. A device according to claim 1, wherein the substrate is flexible.

3. A device according to claim 1, wherein the substrate is made of a conducting material.

4. A device according to claim 2, wherein the substrate comprises a flexible foil.

5. A device according to claim 1 wherein the substrate is made of an insulating material with a conductive coating on the rear surface.

6. A device according to claim 1, wherein the substrate comprises a protective coating on the rear surface the protective coating being sufficiently thin to allow the capacitive coupling between a user's finger and the substrate to be detected.

7. A device according to claim 1, wherein the plurality of layers are operable as an electrophoretic display.

8. A device according to claim 1, wherein the circuitry comprises a plurality of ammeters each connected to a different point on the edge of the substrate.

9. A device according to claim 8, wherein the substrate is substantially rectangular and the plurality of ammeters comprises a respective ammeter placed at each corner of the substrate.

10. Use of a display device as a combined display and input device, the display device comprising a substrate comprising a front surface and a rear surface and a plurality of layers provided on the front surface of the substrate the plurality of layers being operable as a display, wherein the use as a combined display and input device is implemented by using the rear surface of the substrate as a capacitive coupling sheet.
